(19) United States
(12) Patent Application Publication
(10) Pub. No.: US 2010/0125804 A1
(43) Pub. Date: May 20, 2010

(54) OBJECT POSITIONING IN A GRAPHICAL USER INTERFACE

(75) Inventor: Alain R. O'Dea, St. John's (CA)

Correspondence Address: HOFFMAN WARNICK LLC, 75 STATE STREET, 14TH FLOOR, ALBANY, NY, 12207, US

(73) Assignee: INTERNATIONAL BUSINESS MACHINES CORPORATION, Armonk, NY (US)

(21) Appl. No.: 12/272,831

(22) Filed: Nov. 18, 2008

(51) Int. Cl. G06F 3/048

(52) U.S. Cl. 715/767

(57) ABSTRACT

The invention provides a method, system, and program product for positioning an object in a graphical user interface (GUI). In one embodiment, the invention includes determining a position of focus within the GUI and positioning an object within the GUI such that the position of focus is on the object.

### TECHNICAL FIELD

The present invention relates generally to object positioning in a graphical user interface (GUI) and, more particularly, to positioning an object within a GUI based on an input focus of the GUI.

### BACKGROUND OF THE INVENTION

Graphical user interfaces (GUIs) use focus to control where input (e.g., keyboard or mouse entries, audio input, etc.) is added. Typically, focus is used in conjunction with a visual indicator, such as a text entry caret, an outline, a mouse arrow, or some similar feature. However, when a dialog, such as a pop-up window, first appears in a GUI, it is often the case that the control with focus is not near the visual indicator. Generally, dialogs are positioned such that they are centered in the screen or cascaded from a parent dialog. Thus, the visual indicator will be near the focused control in a new dialog only by chance. As a result, a user often has to look around the dialog to discover where the focus is and, as is likely, reposition the visual indicator before inputting data.

Accordingly, there exists a need in the art to overcome the deficiencies and limitations described hereinabove.

### SUMMARY OF THE INVENTION

The invention provides a method, system, and program product for positioning an object in a graphical user interface (GUI).

A first aspect of the invention provides a method of positioning an object within a GUI, the method comprising: determining a position of focus within the GUI; and positioning an object within the GUI such that the position of focus is on the object.

A second aspect of the invention provides a system for positioning an object within a GUI, the system comprising: a system for determining a position of focus within the GUI; and a system for positioning an object within the GUI such that the position of focus is on the object.

A third aspect of the invention provides a program product stored on a computer-readable medium, which when executed, positions an object within a GUI, the program product comprising: program code for determining a position of focus within the GUI; and program code for positioning an object within the GUI such that the position of focus is on the object.

A fourth aspect of the invention provides a method for deploying an application for positioning an object within a GUI, comprising: providing a computer infrastructure being operable to: determine a position of focus within the GUI; and position an object within the GUI such that the position of focus is on the object.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIGS. 1-7 show the positioning of a dialog according to various embodiments of the invention;

FIG. 8 shows a flow diagram of an illustrative method according to an embodiment of the invention; and

FIG. 9 shows a block diagram of an illustrative system according to an embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

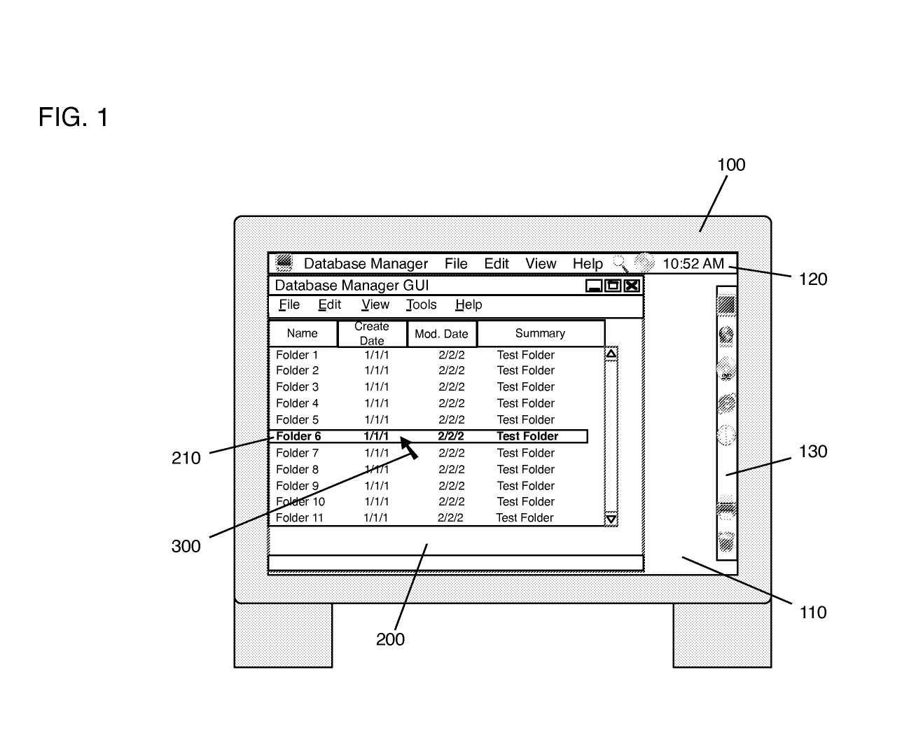

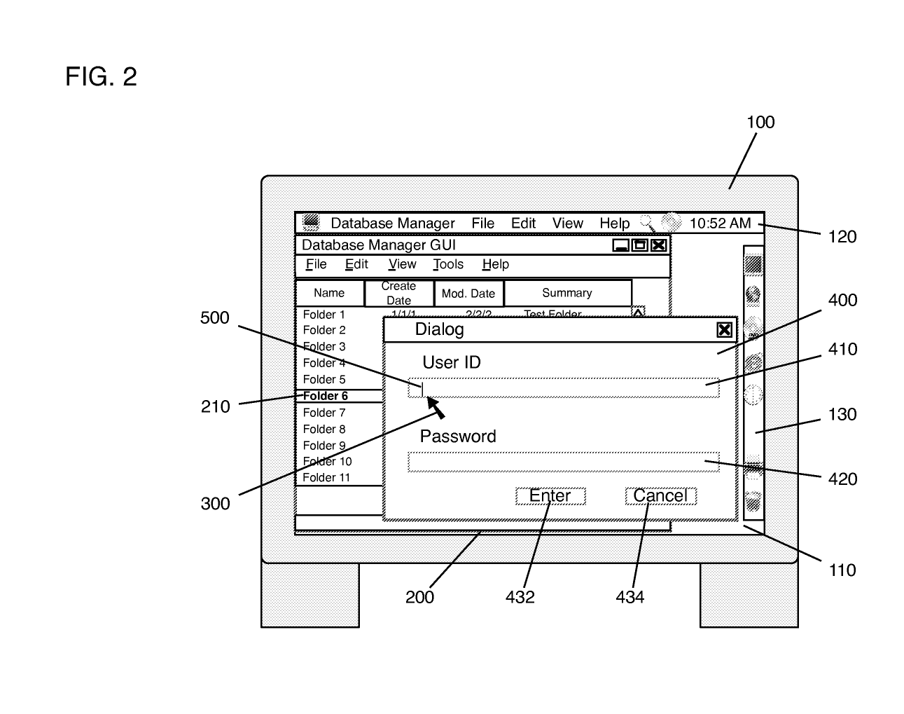

Turning now to the drawings, an embodiment of the invention will be described with reference to FIGS. 1-2. FIG. 1 shows a display 100, upon which is displayed a graphical user interface (GUI) window 200. Also shown on the display 100 are a desktop 110, a system toolbar 120, and a dock 130. The GUI window 200 may include any type of data or objects, as will be recognized by one skilled in the art. Here, the GUI window 200 includes text, a portion of which 210 has been selected using a mouse arrow 300. As noted above, the mouse arrow 300 is a visual indicator of the position of focus. Other visual indicators may include, for example, a cursor, a caret, or an outline.

FIG. 2 shows the display 100 following selection of the selected text 210 (e.g., by double-clicking the selected text 210 using a mouse). A pop-up dialog 400 is displayed in response to such selection, the dialog 400 prompting the user for a user ID and password required to access the data represented by the selected text 210. As can be seen, the dialog 400 includes a user ID text entry field 410 and a password text entry field 420. The dialog 400 further includes enter and cancel buttons 432, 434, as often is the case and will be referred to here generally as “selection buttons.”

As can be seen in FIG. 2, and according to one embodiment of the invention, the dialog 400 has been positioned such that the position of focus (represented by the mouse arrow 300) is on an area manipulable by the user; here, the user ID text entry field 410. The dialog 400 could have been positioned such that the position of focus was on another area manipulable by the user, such as the password text entry field 420, the enter button 432, or the cancel button 434. In any case, however, the position of focus within the display 100 does not change following display of the dialog 400. That is, the dialog 400 is positioned such that the position of focus is on an area of the dialog 400 that a user would need to manipulate; here, the user ID text entry field 410. Positioning the dialog 400 in such a manner greatly improves the ease-of-use of the software and improves a user's efficiency by avoiding the need for the user to search for the position of focus within the dialog 400 or, as is sometimes the case in known methods, within the GUI window 200. As can be seen, a second visual indicator of the position of focus has been included in FIG. 2 in the form of a text entry caret 500 within the user ID text entry field 410. Alternatively, the text entry caret 500 could have been included in place of the mouse arrow 300.

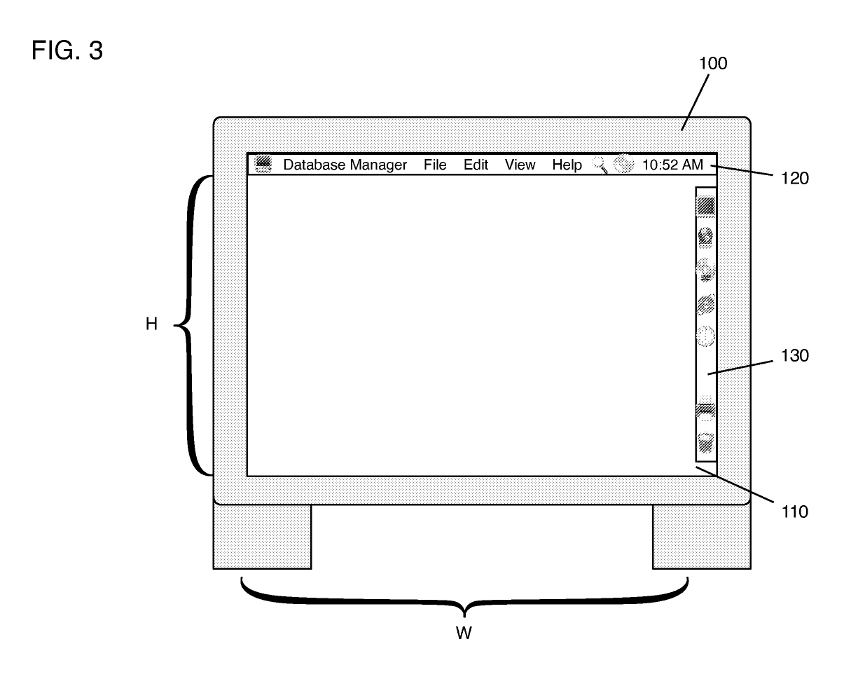

Another aspect of the invention is shown in FIGS. 3-7 and relates to the positioning of a dialog according to positioning constraints. In FIG. 3, the display 100 is again shown, along with the dimensions of its “useful display region.” As used herein, a GUI's useful display region may be defined as the portion of the desktop 110 that is not occupied by a system toolbar 120, a taskbar (not shown), a dock 130, or similar feature. The GUI's useful display region has a height H and width W, within which a dialog or, as the case may be, a portion of a dialog, may be displayed. In some cases, the height and width of a dialog will be less than the height H and width W of the useful display region. In such a case, the dialog will be positioned entirely within the useful display region, as shown in FIG. 2. In other cases the height, width, or both, of a dialog will be greater than the height H, width W, or both, of the useful display region.

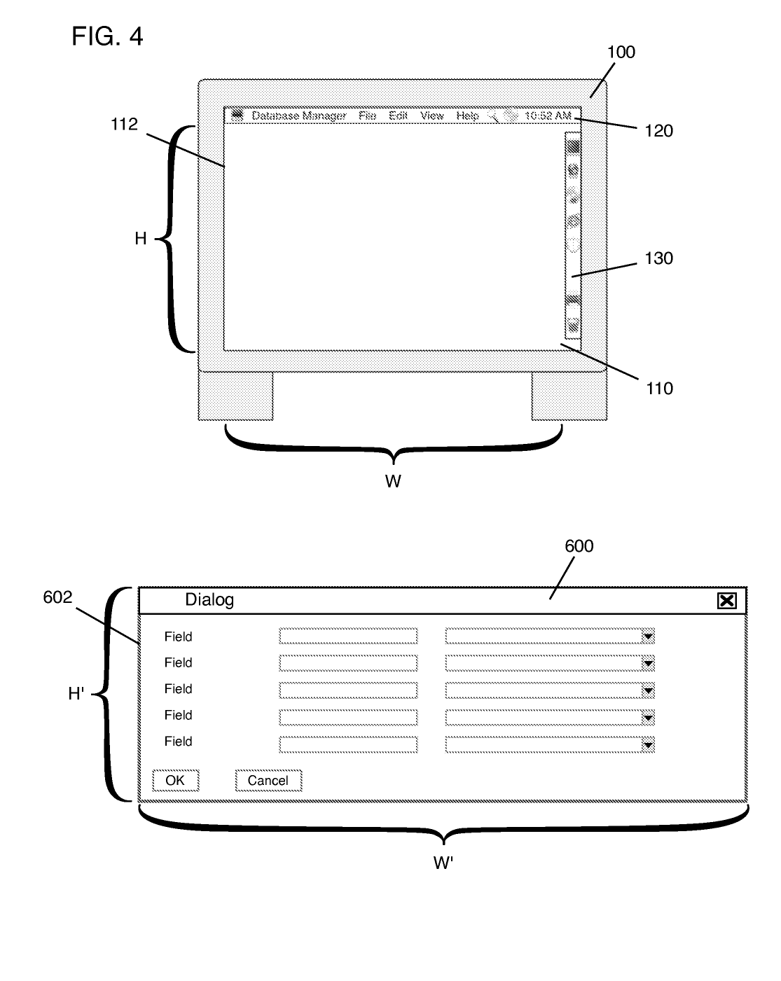

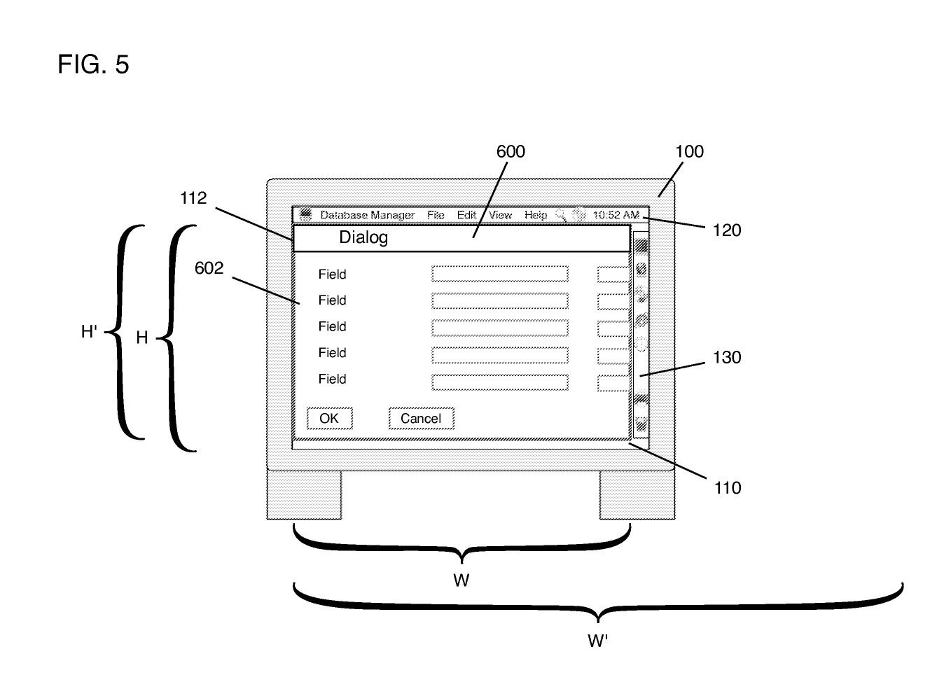

For example, in FIG. 4, it can be seen that the width W″ of the dialog 600 exceeds the width W of the useful display region. In such a case, the dialog 600 will be positioned such that a left edge 602 of the dialog 600 aligns with a left edge 112 of the useful display region (i.e., the portion of the desktop 110 not occupied by the system toolbar 120, a taskbar (not shown), a dock 130, or similar feature). The dialog 600 is shown so positioned in FIG. 5.

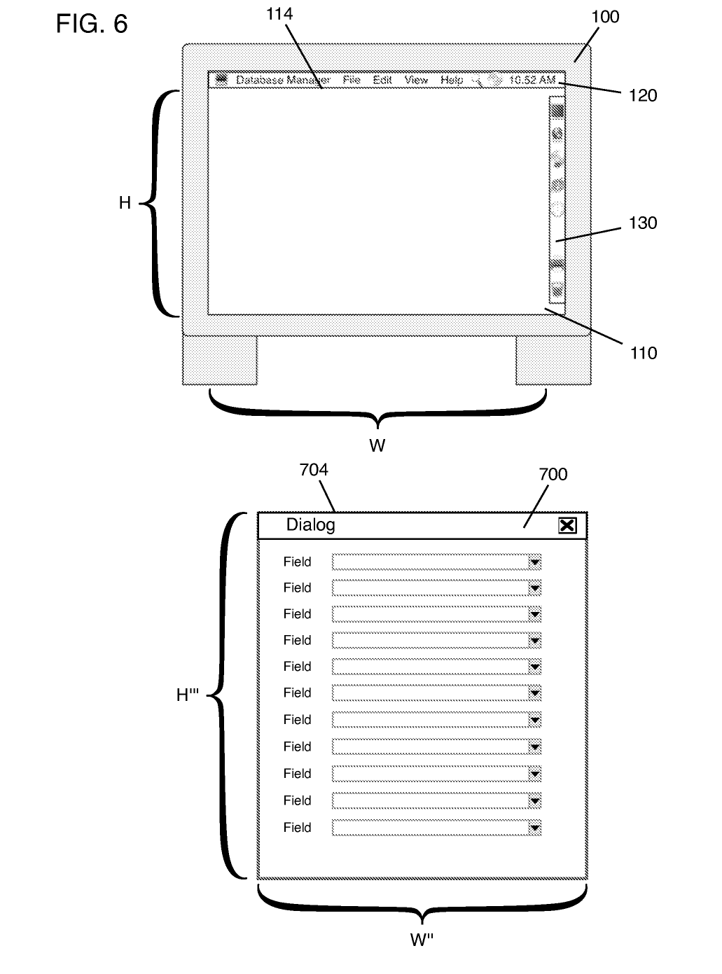

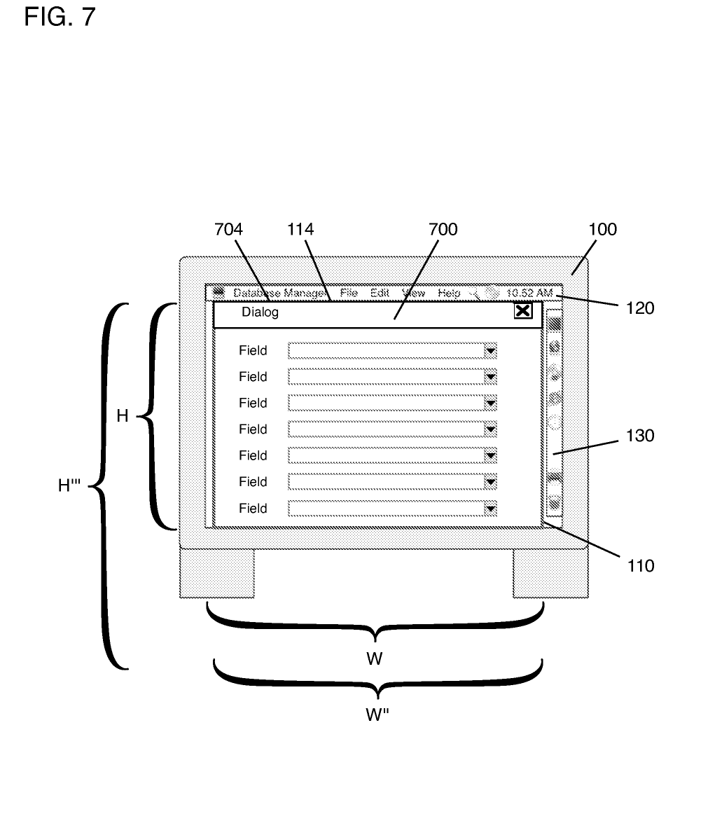

In FIG. 6, it can be seen that that height H″ of the dialog 700 exceeds the height H of the useful display region. In such a case, the dialog 700 will be positioned such that a top edge 704 of the dialog 700 aligns with a top edge 114 of the useful display region. The dialog 700 is shown so positioned in FIG. 7. It should be recognized, of course, that the positionings shown in FIGS. 4-5 and 6-7 are not mutually exclusive. That is, a dialog could be positioned such that its left edge aligns with a left edge of the useful display region and its top edge aligns with the top edge of the useful display region. Such a case may arise, for example, where the height and width of the dialog are greater than the height and width of the useful display region.

It should be recognized that while the positionings described above related to the positioning of a dialog, the present invention is applicable to the positioning of any object within a GUI. Such objects include, for example, application windows, graphics, videos, etc.

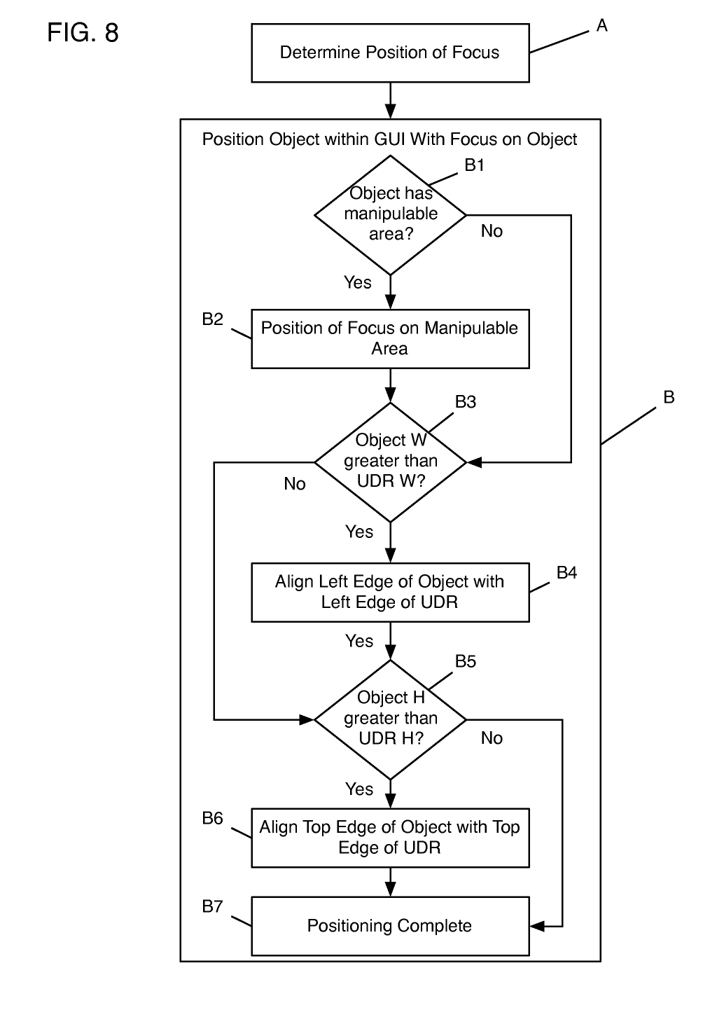

FIG. 8 shows a flow diagram of an illustrative method according to the invention. At A, the position of focus within the GUI is determined. At B, an object (e.g., a dialog) is positioned within the GUI such that the position of focus is on the object. As noted above with respect to FIGS. 2-7, such positioning may include a number of additional decisions and actions. At B1, it is determined whether the object has an area manipulable by a user (e.g., a text entry field). If so (i.e., Yes at B1), the object is positioned such that the position of focus is on the manipulable area at B2. If not (i.e., No at B1), or following the positioning at B2, it is determined at B3 whether a width of the object is greater than a width of the useful display region (UDR). If so (i.e., Yes at B3), a left edge of the object is aligned with a left edge of the UDR at B4. If not (i.e., No at B3), or following the aligning at B4, it is determined whether a height of the object is greater than a height of the UDR. If so (i.e., Yes at B5), a top edge of the object is aligned with a top edge of the UDR at B6. If not (i.e., No at B5), or following the aligning at B6, the positioning of the object is deemed complete at B7.

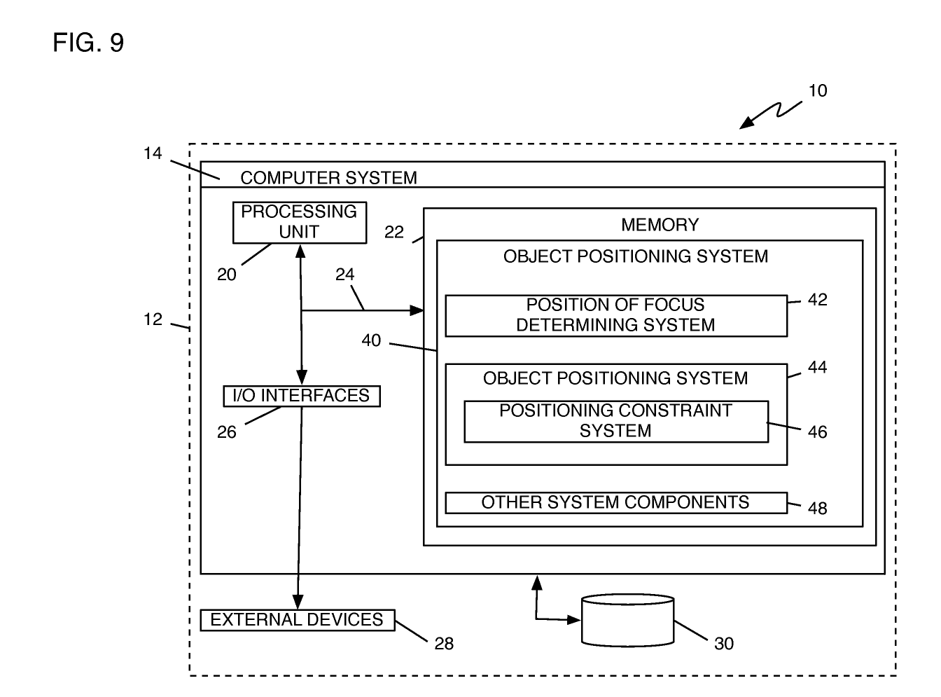

FIG. 9 shows an illustrative system 10 for positioning an object within a GUI. To this extent, system 10 includes a computer infrastructure 12 that can perform the various process steps described herein for positioning an object within a GUI. In particular, computer infrastructure 12 is shown including a computer system 14 that comprises an object positioning system 40, which enables computer system 14 to position an object within a GUI by performing the process steps of the invention.

Computer system 14 is shown including a processing unit 20, a memory 22, input/output (I/O) interfaces 26, and a bus 24. Further, computer system 14 is shown in communication with external devices 28 and a storage system 30. As is known in the art, in general, processing unit 20 executes computer program code, such as object positioning system 40, that is stored in memory 22 and/or storage system 30. While executing computer program code, processing unit 20 can read and/or write data from/to memory 22, storage system 30, and/or I/O interface 26. Bus 24 provides a communication link between each of the components in computer system 14. External devices 28 can comprise any device that enables a user (not shown) to interact with computer system 14 or any device that enables computer system 14 to communicate with one or more other computer systems.

In any event, computer system 14 can comprise any general purpose computing article of manufacture capable of executing computer program code installed by a user (e.g., a personal computer, server, handheld device, etc.). However, it is understood that computer system 14 and object positioning system 40 are only representative of various possible computer systems that may perform the various process steps of the invention. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 12 is only illustrative of various types of computer infrastructures for implementing the invention. For example, in one embodiment, computer infrastructure 12 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

As previously mentioned, the object positioning system 40 enables the computer system 14 to position an object within a GUI. To this extent, the object positioning system 40 is shown including a position of focus determining system 42 and an object positioning system 44. As described above, the object positioning system 44 may include a positioning constraint system 46. Operation of each of these systems is discussed above. The object positioning system 40 may further include other system components 48 to provide additional or improved functionality to the object positioning system 40. It is understood that some of the various systems shown in FIG. 9 can be implemented independently, combined, and/or stored in memory for one or more separate computer systems 14 that communicate over a network. Further, it is understood that some of the systems and/or functionality may not be implemented, or additional systems and/or functionality may be included as part of system 10.

While shown and described herein as a method and system for positioning, it is understood that the invention further provides various alternative embodiments. For example, in one embodiment, the invention provides a computer-readable medium that includes computer program code to enable a computer infrastructure to position an object within a GUI. To this extent, the computer-readable medium includes program code, such as object positioning system 40, that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as memory 22 and/or storage system 30 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to position an object within a GUI, as described above. In this case, the service provider can create, maintain, support, etc., a computer infrastructure, such as computer infrastructure 12, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for positioning an object within a GUI. In this case, a computer infrastructure, such as computer infrastructure 12, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as computer system 14, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of positioning an object within a graphical user interface (GUI), the method comprising:
determining a position of focus within the GUI; and
positioning an object within the GUI such that position of focus is on the object.

2. The method of claim 1, wherein the GUI includes a visual indicator of the position of focus.

3. The method of claim 2, wherein the visual indicator is selected from a group consisting of: a cursor, a caret, an outline, and a mouse arrow.

4. The method of claim 1, wherein the object includes at least one area manipulable by a user.

5. The method of claim 4, wherein the manipulable area is selected from a group consisting of: a text entry field and a selection button.

6. The method of claim 4, wherein the object is positioned such that focus is on an area manipulable by the user.

7. The method of claim 1, wherein the object is positioned according to positioning constraints.

8. The method of claim 7, wherein an object smaller in both a horizontal direction and a vertical direction than a screen on which the GUI is displayed is positioned entirely within an area of the screen not occupied by a system toolbar, a taskbar, or a dock.

9. The method of claim 7, wherein an object larger in a horizontal direction than a screen on which the GUI is displayed is positioned such that a left edge of the object is positioned at a left edge of an area of the screen not occupied by a system toolbar, a taskbar, or a dock.

10. The method of claim 7, wherein an object larger in a vertical direction than a screen on which the GUI is displayed is positioned such that a top edge of the object is positioned at a top edge of an area of the screen not occupied by a system toolbar, a taskbar, or a dock.

11. A system for positioning an object within a graphical user interface (GUI), the system comprising:
a system for determining a position of focus within the GUI; and
a system for positioning an object within the GUI such that focus is on the object.

12. The system of claim 11, wherein the GUI includes a visual indicator of the position of focus selected from a group consisting of: a cursor, a caret, an outline, and a mouse arrow.

13. The system of claim 11, wherein the object includes at least one area manipulable by a user.

14. The system of claim 13, wherein the system for positioning is capable of positioning the object such that the focus is on an area manipulable by the user.

15. The system of claim 11, wherein the system for positioning is capable of positioning the object according to at least one positioning constraint selected from a group consisting of:
in the case that an object is smaller in both a horizontal direction and a vertical direction than a screen on which the GUI is displayed, positioning the object entirely within an area of the screen not occupied by a system toolbar, a taskbar, or a dock;
in the case that an object is larger in a horizontal direction than a screen on which the GUI is displayed, positioning the object such that a left edge of the object is positioned at a left edge of an area of the screen not occupied by a system toolbar, a taskbar, or a dock; and
in the case than an object is larger in a vertical direction than a screen on which the GUI is displayed, positioning the object such that a top edge of the object is positioned at a top edge of an area of the screen not occupied by a system toolbar, a taskbar, or a dock.

16. A program product stored on a computer-readable medium, which when executed, positions an object within a graphical user interface (GUI), the program product comprising:
program code for determining a position of focus within the GUI; and
program code for positioning an object within the GUI such that focus is on the object.

17. The program product of claim 16, wherein the object is positioned such that focus is on an area of the object manipulable by a user.

18. The program product of claim 16, wherein the program code for positioning is operable to position the object such that:
in the case that an object is smaller in both a horizontal direction and a vertical direction than a screen on which the GUI is displayed, positioning the object entirely within an area of the screen not occupied by a system toolbar, a taskbar, or a dock;
in the case that an object is larger in a horizontal direction than a screen on which the GUI is displayed, positioning the object such that a left edge of the object is positioned at a left edge of an area of the screen not occupied by a system toolbar, a taskbar, or a dock; and
in the case than an object is larger in a vertical direction than a screen on which the GUI is displayed, positioning the object such that a top edge of the object is positioned at a top edge of an area of the screen not occupied by a system toolbar, a taskbar, or a dock.

19. A method for deploying an application for positioning an object within a graphical user interface (GUI), comprising:
providing a computer infrastructure being operable to:
determine a position of focus within the GUI; and
position an object within the GUI such that focus is on the object.

20. The method of claim 19, wherein the computer infrastructure is operable to:
in the case that an object is smaller in both a horizontal direction and a vertical direction than a screen on which the GUI is displayed, position the object entirely within an area of the screen not occupied by a system toolbar, a taskbar, or a dock;
in the case that an object is larger in a horizontal direction than a screen on which the GUI is displayed, position the object such that a left edge of the object is positioned at a left edge of an area of the screen not occupied by a system toolbar, a taskbar, or a dock; and
in the case than an object is larger in a vertical direction than a screen on which the GUI is displayed, position the object such that a top edge of the object is positioned at a top edge of an area of the screen not occupied by a system toolbar, a taskbar, or a dock.
